(19) United States
(12) Patent Application Publication
(10) Pub. No.: US 2025/0381909 A1
(43) Pub. Date: Dec. 18, 2025

(54) PATIENT SUPPORT APPARATUS HAVING POWER INDICATOR TRANSPORT LIGHT

(71) Applicant: Hill-Rom Services, Inc., Batesville, IN (US)

(72) Inventors: Brandon P. Fisk, Brookville, IN (US); Douglas A. Seim, Okeana, OH (US); Jonathan Keith Moenter, Batesville, IN (US); Gavin M. Monson, Oxford, OH (US); Jonathan D. Turner, Batesville, IN (US); Robert Mark Zerhusen, Batesville, IN (US); David C. Newkirk, Lawrenceburg, IN (US); Trevor Jones, Prospect Heights, IL (US)

(73) Assignee: Hill-Rom Services, Inc., Batesville, IN (US)

(21) Appl. No.: 19/233,398

(22) Filed: Jun. 10, 2025

Related U.S. Application Data
(60) Provisional application No. 63/660,720, filed on Jun. 17, 2024.

(51) Int. Cl. B60Q 1/44; A61G 7/05; A61G 7/08; B60B 33/02; B60Q 1/50

(52) U.S. Cl. CPC B60Q 1/44; A61G 7/0528; A61G 7/08; B60B 33/021; A61G 2203/36; A61G 2203/72; B60B 2200/24; B60Q 1/525

(57) ABSTRACT

A patient support apparatus includes a lower frame, an upper frame, and a power indicator transport light coupled to one of the lower frame and the upper frame. The power indicator transport light is configured to provide notice to surrounding areas that the patient support apparatus is in close proximity during transportation of the patient support apparatus so that collisions with the patient support apparatus are minimized.

### CROSS-REFERENCE TO RELATED APPLICATIONS

This application claims priority to U.S. Provisional Application No. 63/660,720 filed on Jun. 17, 2024, the entire disclosure of which is incorporated herein by reference.

### BACKGROUND

The present disclosure relates to patient support apparatuses. More particularly, the present disclosure relates to patient support apparatuses having lights.

Generally, while a caregiver transports a patient support apparatus, people may accidentally collide with the patient support apparatus. Some facilities install mirrors in hallways at intersections and/or corners so that people and caregivers can see what is around the corner. However, mirrors may not draw attention to the patient support apparatus as the patient support apparatus is being transported. Thus, providing notice to people and caregivers that a patient support apparatus is in close proximity would be beneficial.

### SUMMARY

An apparatus, system, or method may comprise one or more of the features recited in the appended claims and/or the following features which, alone or in any combination, may comprise patentable subject matter:

According to the present disclosure, a patient support apparatus may be provided. The patient support apparatus may include a frame and a power indicator transport light. The frame may be positioned above a floor. The frame may extend between a head end and a foot end thereof along an axis. The power indicator transport light may be coupled with the frame. The power indicator transport light may be configured to change between an alert mode in which the power indicator transport light projects an indicator on the floor underlying the frame forward of the foot end of the frame in response to the patient support apparatus being in a transport mode during which the patient support apparatus is moving and an off mode in which the power indicator transport light does not project the indicator on the floor in response to the patient support apparatus being in a stationary mode in which the patient support apparatus is not moving.

Optionally, the power indicator transport light may comprise a laser. The power indicator transport light may comprise at least one light emitting diode. The frame may include a lower frame and an upper frame supported above the lower frame and configured to support a patient. The power indicator transport light may be coupled to a forward end of the lower frame. The indicator may be projected by the power indicator transport light perpendicularly along the floor relative to the axis. The indicator may form a line on the floor that extends perpendicularly along the floor relative to the axis.

Further optionally, the power indicator transport light may be coupled to an underside of the upper frame. The indicator may form a symbol on the floor. The patient support apparatus may further comprise a first siderail coupled to a first side of the upper frame and a second siderail coupled to a second side of the upper frame opposite the first side. The power indicator transport light may comprise a first power indicator transport light coupled to an underside of the first siderail and a second power indicator transport light coupled to an underside of the second siderail. The first power indicator transport light may be coupled to an angled portion of the first siderail relative to the floor. The second power indicator transport light may be coupled to an angled portion of the second siderail relative to the floor. The first power indicator transport light may form a first indicator along the floor extending parallel to the axis and the second power indicator transport light may form a second indicator along the floor extending parallel to the axis.

If desired, the indicator may be projected on the floor at least five feet forward of the foot end of the frame. The indicator may flash on the floor. The patient support apparatus may further comprise a plurality of casters configured to support the frame on the floor. The plurality of casters may change between a brake mode in which rotation and swiveling of each of the plurality of casters is prevented and a steer mode in which one of the plurality of casters is prevented from swiveling while the one of the plurality of casters is free to rotate. In response to the plurality of casters being in the steer mode, the patient support apparatus may be in the transport mode. In response to the plurality of casters being in the brake mode, the patient support apparatus may be in the stationary mode.

Alternatively, the patient support apparatus may further comprise a controller in communication with the power indicator transport light. The controller may include a processor and a memory having instructions stored therein which, when executed by the processor, cause the processor to control the power indicator transport light to change between the off mode and the alert mode in response to determining that the patient support apparatus is in the stationary mode or in the transport mode, respectively. The controller may be configured to receive a first signal from a sensor indicative of the plurality of casters being in the steer mode and the patient support apparatus being in the transport mode. In response to the first signal, the controller may change the power indicator transport light from the off mode to the alert mode. The controller may be configured to receive a second signal from the sensor indicative of the plurality of casters being in the brake mode and the patient support apparatus being in the stationary mode. In response to the second signal, the controller may change the power indicator transport light from the alert mode to the off mode.

Additionally, the controller may be configured to receive a first signal from a sensor indicative of the patient support apparatus changing from the stationary mode to the transport mode. In response to the first signal, the controller may change the power indicator transport light from the off mode to the alert mode. The controller may be configured to receive a second signal from the sensor indicative of the patient support apparatus changing from the transport mode to the stationary mode. In response to the second signal, the controller may change the power indicator transport light from the alert mode to the off mode. The first signal may indicate that a powered drive wheel included in the patient support apparatus is activated.

Further according to the present disclosure, a patient support apparatus may be provided. The patient support apparatus may include a lower frame, an upper frame, and a power indicator transport light. The lower frame may be positioned above a floor underlying the patient support apparatus. The upper frame may be supported above the lower frame and configured to support a patient. The upper frame may extend between a head end and a foot end thereof along an axis. The power indicator transport light may be coupled with one of the lower frame and the upper frame and may be configured to provide notice to surrounding areas that the patient support apparatus is in close proximity during transportation of the patient support apparatus so that collisions with the patient support apparatus are minimized. The power indicator transport light may change between an alert mode in which the power indicator transport light projects an indicator on the floor underlying the patient support apparatus forward of the foot end of the patient support apparatus in response to the patient support apparatus being in a transport mode during which the patient support apparatus is being transported and an off mode in which the power indicator transport light does not project the indicator on the floor in response to the patient support apparatus being in a stationary mode in which the patient support apparatus is not moving.

Optionally, the power indicator transport light may comprise a laser. The power indicator transport light may comprise at least one light emitting diode. The power indicator transport light may be coupled to a forward end of the lower frame. The indicator may be projected by the power indicator transport light perpendicularly along the floor relative to the axis. The indicator may form a line on the floor that extends perpendicularly along the floor relative to the axis. The indicator may be projected on the floor at least five feet forward of the foot end of the upper frame. The indicator may flash on the floor. The power indicator transport light may be coupled to an underside of the upper frame. The indicator may form a symbol on the floor.

Further optionally, the patient support apparatus may further comprise a first siderail coupled to a first side of the upper frame and a second siderail coupled to a second side of the upper frame opposite the first side. The power indicator transport light may comprise a first power indicator transport light coupled to an underside of the first siderail and a second power indicator transport light coupled to an underside of the second siderail. The first power indicator transport light may be coupled to an angled portion of the first siderail relative to the floor. The second power indicator transport light may be coupled to an angled portion of the second siderail relative to the floor. The first power indicator transport light may form a first indicator along the floor extending parallel to the axis and the second power indicator transport light may form a second indicator along the floor extending parallel to the axis.

If desired, the power indicator transport light may automatically change from the off mode to the alert mode in response to the patient support apparatus changing from the stationary mode to the transport mode. The patient support apparatus may further comprise a plurality of casters configured to support the lower frame on the floor. The plurality of casters may change between a brake mode in which rotation and swiveling of each of the plurality of casters is prevented and a steer mode in which one of the plurality of casters is prevented from swiveling while the one of the plurality of casters is free to rotate. In response to the plurality of casters being in the steer mode, the patient support apparatus may be in the transport mode. In response to the plurality of casters being in the brake mode, the patient support apparatus may be in the stationary mode.

Alternatively, the patient support apparatus may further comprise a controller operable to receive a first signal from a sensor indicative of the plurality of casters being in the steer mode and the patient support apparatus being in the transport mode. In response to the first signal, the controller may change the power indicator transport light from the off mode to the alert mode. The controller may be operable to receive a second signal from the sensor indicative of the plurality of casters being in the brake mode and the patient support apparatus being in the stationary mode. In response to the second signal, the controller may change the power indicator transport light from the alert mode to the off mode.

Additionally, the patient support apparatus may further comprise a controller operable to receive a first signal from a sensor indicative of the patient support apparatus changing from the stationary mode to the transport mode. In response to the first signal, the controller may change the power indicator transport light from the off mode to the alert mode. The controller may be operable to receive a second signal from the sensor indicative of the patient support apparatus changing from the transport mode to the stationary mode. In response to the second signal, the controller may change the power indicator transport light from the alert mode to the off mode. The first signal may indicate that a powered drive wheel included in the patient support apparatus is activated.

Further according to the present disclosure, a patient support apparatus may be provided. The patient support apparatus may include a frame, a power indicator transport light, and a controller. The frame may be positioned above a floor and configured to support a patient. The frame may extend between a head end and a foot end thereof along an axis. The power indicator transport light may be coupled with the frame and configured to change between an alert mode in which the power indicator transport light projects an indicator on the floor underlying the frame forward of the foot end of the frame in response to the patient support apparatus being in a transport mode during which the patient support apparatus is moving and an off mode in which the power indicator transport light does not project the indicator on the floor in response to the patient support apparatus being in a stationary mode in which the patient support apparatus is not moving. The controller may be in communication with the power indicator transport light. The controller may include a processor and a memory having instructions stored therein which, when executed by the processor, cause the processor to control the power indicator transport light to change between the off mode and the alert mode in response to determining that the patient support apparatus is in the stationary mode or in the transport mode, respectively.

Optionally, the power indicator transport light may comprise a laser. The power indicator transport light may comprise at least one light emitting diode. The frame may include a lower frame and an upper frame supported above the lower frame. The power indicator transport light may be coupled to a forward end of the lower frame. The indicator may be projected by the power indicator transport light perpendicularly along the floor relative to the axis. The indicator may form a line on the floor that extends perpendicularly along the floor relative to the axis.

Further optionally, the power indicator transport light may be coupled to an underside of the upper frame. The indicator may form a symbol on the floor.

If desired, the patient support apparatus may further comprise a first siderail coupled to a first side of the upper frame and a second siderail coupled to a second side of the upper frame opposite the first side. The power indicator transport light may comprise a first power indicator transport light coupled to an underside of the first siderail and a second power indicator transport light coupled to an underside of the second siderail. The first power indicator transport light may be coupled to an angled portion of the first siderail relative to the floor. The second power indicator transport light may be coupled to an angled portion of the second siderail relative to the floor. The first power indicator transport light may form a first indicator along the floor extending parallel to the axis and the second power indicator transport light may form a second indicator along the floor extending parallel to the axis.

Alternatively, the indicator may be projected on the floor at least five feet forward of the foot end of the frame. The indicator may flash on the floor. The patient support apparatus may further comprise a plurality of casters configured to support the frame on the floor. The plurality of casters may change between a brake mode in which rotation and swiveling of each of the plurality of casters is prevented and a steer mode in which one of the plurality of casters is prevented from swiveling while the one of the plurality of casters is free to rotate. In response to the plurality of casters being in the steer mode, the patient support apparatus may be in the transport mode. In response to the plurality of casters being in the brake mode, the patient support apparatus may be in the stationary mode.

Additionally, the controller may be configured to receive a first signal from a sensor indicative of the plurality of casters being in the steer mode and the patient support apparatus being in the transport mode. In response to the first signal, the controller may change the power indicator transport light from the off mode to the alert mode. The controller may be configured to receive a second signal from the sensor indicative of the plurality of casters being in the brake mode and the patient support apparatus being in the stationary mode. In response to the second signal, the controller may change the power indicator transport light from the alert mode to the off mode. The controller may be configured to receive a first signal from a sensor indicative of the patient support apparatus changing from the stationary mode to the transport mode. In response to the first signal, the controller may change the power indicator transport light from the off mode to the alert mode. The controller may be configured to receive a second signal from the sensor indicative of the patient support apparatus changing from the transport mode to the stationary mode. In response to the second signal, the controller may change the power indicator transport light from the alert mode to the off mode. The first signal may indicate that a powered drive wheel included in the patient support apparatus is activated.

Further according to the present disclosure, a controller may be provided. The controller may include a processor and a memory. The memory may have instructions stored therein executable by the processor to cause the processor to (a) determine a status of a patient support apparatus and (b) in response to determining that the patient support apparatus is in a transport mode, outputting a signal to a power indicator transport light coupled with a frame of the patient support apparatus to cause the power indicator transport light to change from an off mode to an alert mode in which the power indicator transport light projects an indicator on a floor underlying the patient support apparatus forward of the patient support apparatus.

Optionally, the instructions stored in the memory may further include instructions executable by the processor to cause the processor to output a signal to the power indicator transport light to cause the power indicator transport light to change from the alert mode to the off mode in which the power indicator transport light does not project the indicator on the floor in response to the controller determining that the patient support apparatus is in a stationary mode.

Further according to the present disclosure, a method may be provided. The method may include coupling a power indicator transport light to a frame of a patient support apparatus. The method may include determining a status of the patient support apparatus. The method may include, in response to determining that the status of the patient support apparatus is a transport mode, changing the power indicator transport light from an off mode to an alert mode in which the power indicator transport light projects an indicator on a floor underlying the frame forward of a foot end of the frame. The method may include, in response to determining that the status of the patient support apparatus is a stationary mode, changing the power indicator transport light from the alert mode to the off mode in which the power indicator transport light does not project the indicator on the floor.

Optionally, the step of changing the power indicator transport light from an off mode to an alert mode may include projecting the indicator perpendicularly along the floor relative to an axis extending through the patient support apparatus. The step of changing the power indicator transport light from an off mode to an alert mode may include projecting the indicator on the floor as a symbol. The step of changing the power indicator transport light from an off mode to an alert mode may include projecting a first indicator on the floor and a second indicator on the floor such that the first and second indicators extend along the floor parallel to an axis extending through the patient support apparatus. The step of changing the power indicator transport light from an off mode to an alert mode may include projecting the indicator on the floor at least five feet forward of the foot end of the frame.

Additional features, which alone or in combination with any other feature(s), such as those listed above and/or those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The foregoing and other features of the various embodiments of the methods and apparatuses described herein will become more apparent from the following detailed description and the accompanying drawings in which:

FIG. 1 is a perspective view of a patient support apparatus having a lower frame supported above a floor underlying the patient support apparatus, an upper frame supported above the lower frame, and a power indicator transport light coupled with the lower frame and configured to provide an alert to surrounding areas that the patient support apparatus is in close proximity during transportation of the patient support apparatus;

FIG. 2 is a side view of the patient support apparatus of FIG. 1 showing that the power indicator transport light is coupled with the lower frame to project an indicator on the floor forward of a foot end of the patient support apparatus;

FIG. 3 is a top down view of the patient support apparatus of FIG. 2 showing that the power indicator transport light projects the indicator on the floor such that the indicator extends perpendicularly along the floor relative to the patient support apparatus;

FIG. 4 is a block diagram of a control system of the patient support apparatus of FIG. 1 showing a controller coupled to various sensors and the power indicator transport light to control the power indicator transport light based on inputs from the various sensors;

FIG. 5 is a side view of a patient support apparatus, similar to FIG. 1, showing an alternative power indicator transport light coupled with side rails of the patient support apparatus;

FIG. 6 is a top down view of the patient support apparatus of FIG. 5 showing that the power indicator transport light projects an indicator on the floor such that the indicator extends parallel along the floor relative to the patient support apparatus;

FIG. 7 is a perspective view of an alternative patient support apparatus having a lower frame supported above a floor underlying the patient support apparatus, an upper frame supported above the lower frame, and a power indicator transport light coupled with the upper frame and configured to provide an alert to surrounding areas that the patient support apparatus is in close proximity during transportation of the patient support apparatus;

FIG. 8 is a side view of the patient support apparatus of FIG. 7 showing that the power indicator transport light is coupled with the upper frame to project an indicator on the floor forward of a foot end of the patient support apparatus; and

FIG. 9 is a top down view of the patient support apparatus of FIG. 7 showing that the power indicator transport light projects the indicator on the floor as an icon displayed on the floor.

### DETAILED DESCRIPTION

The present disclosure relates to a patient support apparatus 10 that provides notice to surrounding areas that the patient support apparatus 10 is in close proximity during transport of the patient support apparatus 10. Generally, patient support apparatuses and people, such as those walking through hallways, may collide due to inadequate notice that the patient support apparatus is nearby. Thus, the patient support apparatus 10 includes a power indicator transport light 16 configured to provide notice to surrounding areas that the patient support apparatus 10 is in close proximity during transport of the patient support apparatus 10 so that collisions with the patient support apparatus 10 are minimized.

Some hallways and/or corners include mounted mirrors so that people can see objects and/or people in adjacent hallways. However, mounted mirrors may not draw attention to large objects, and those unfamiliar with their surroundings may not be aware of the presence of the mounted mirrors or the importance of looking at the mounted mirrors before turning a corner. Thus, the power indicator transport light 16 draws attention to the patient support apparatus 10 rather than relying on familiarity of looking to a mounted mirror.

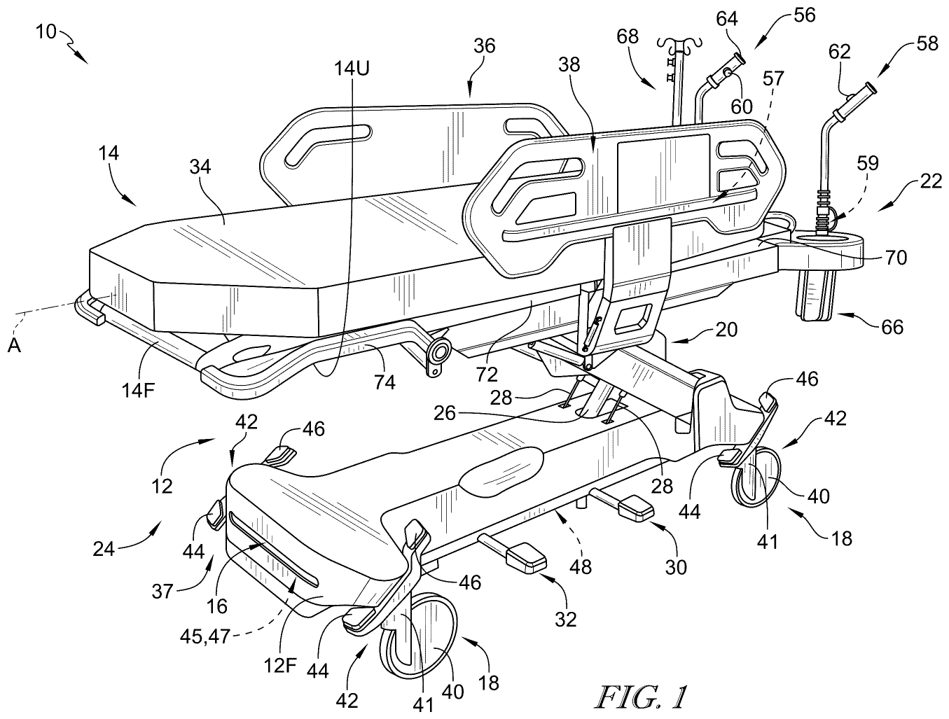

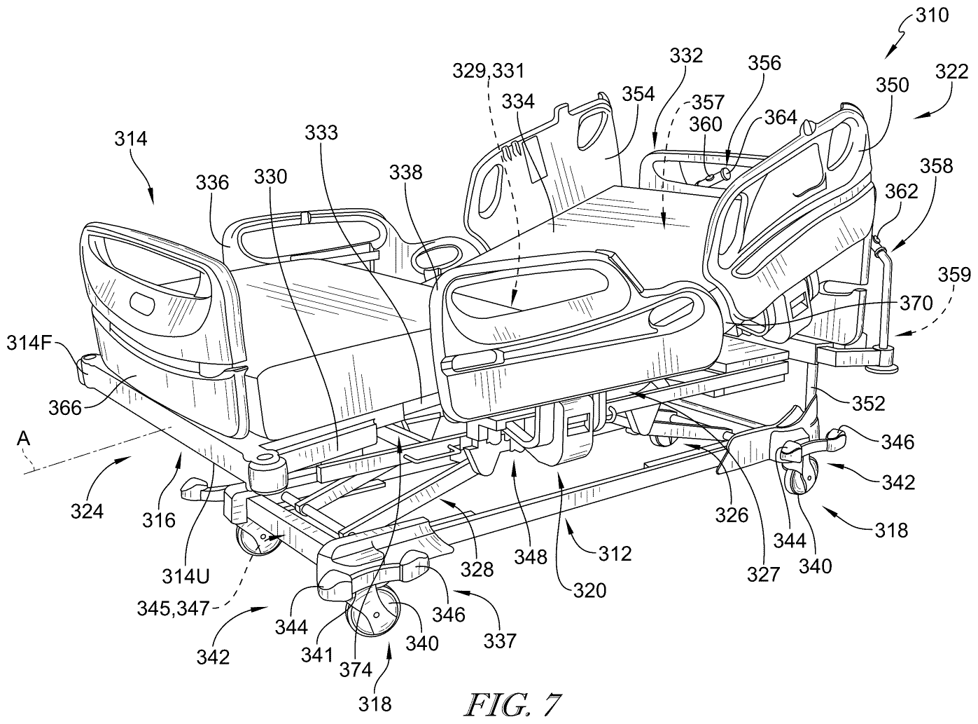

In some embodiments, the patient support apparatus 10 is illustratively a stretcher 10, as shown in FIG. 1. In some embodiments, the patient support apparatus 10 is illustratively a hospital bed 310, as shown in FIG. 7. The present disclosure is applicable to other patient support apparatuses including, for example, other types of beds, patient tables, wheel chairs, and the like. As will be described in further detail below, the present disclosure is focused primarily on various power indicator transport lights that alert to surrounding areas that the patient support apparatus 10 is being transported and is in close proximity.

The patient support apparatus 10 includes a lower frame 12, an upper frame 14, and a power indicator transport light 16, as shown in FIG. 1. The lower frame 12 is supported on a plurality of casters 18 above a floor underlying the patient support apparatus 10. The plurality of casters 18 roll along the floor as the patient support apparatus 10 is transported from one location to another. The upper frame 14 is configured to support a patient thereon. The power indicator transport light 16 is illustratively coupled with the lower frame 12 and configured to provide notice to surrounding areas that the patient support apparatus 10 is in close proximity during transport of the patient support apparatus 10 so that collisions with the patient support apparatus 10 are minimized.

The lower frame 12 supports a lift mechanism 20 near a head end 22 of the patient support apparatus 10, as shown in FIG. 1. The patient support apparatus 10 extends between the head end 22 and a foot end 24 thereof along an axis A (i.e., along a longitudinal length of the patient support apparatus 10 that extends between the head end 22 and the foot end 24 thereof). The lift mechanism 20 provides cantilevered support of the upper frame 14 and is configured to raise, lower, and tilt the upper frame 14 relative to the lower frame 12 while the lift mechanism 20 is activated. In some embodiments, the lift mechanism 20 is operated by a hydraulic cylinder 26 that is assisted by a pair of gas springs 28 as the lift mechanism 20 moves between various positions. The hydraulic cylinder 26 is operated by a pedal 30, which may be acted upon by a caregiver with their foot to pump hydraulic fluid from a reservoir into the hydraulic cylinder 26 to cause the hydraulic cylinder 26 to extend and affect the movement of the lift mechanism 20. In the present embodiment, the hydraulic cylinder 26 is a single acting cylinder. To lower the lift mechanism 20, a pedal 32 may be activated by a caregiver to open a release valve between the hydraulic cylinder 26 and the reservoir to allow hydraulic fluid to be urged into the reservoir by the weight of the structure supported on the lift mechanism 20.

The upper frame 14 is supported above the lower frame 12 and configured to support a patient thereon, as suggested in FIG. 1. The upper frame 14 supports a mattress 34. The upper frame 14 also supports a right siderail 36 and a left siderail 38 of the patient support apparatus 10. The siderails 36, 38 are spaced from each other in a lateral dimension of the patient support apparatus 10, as shown in FIG. 1. The siderails 36, 38 are shown in raised positions in FIG. 1, but the siderails may be lowered. The orientation of the sides and ends of the patient support apparatus 10 is established by the orientation of a patient supported on the patient support apparatus 10 in a supine position such that the right siderail 36 is positioned to the patient's right and the left siderail 38 is positioned to the patient's left. Similarly, references to the foot end 24 relate to the position of the patient's feet when in the supine position on the patient support apparatus 10. Likewise, the head end 22 is oriented at the end of the patient support apparatus 10 where a patient's head would be in a supine position.

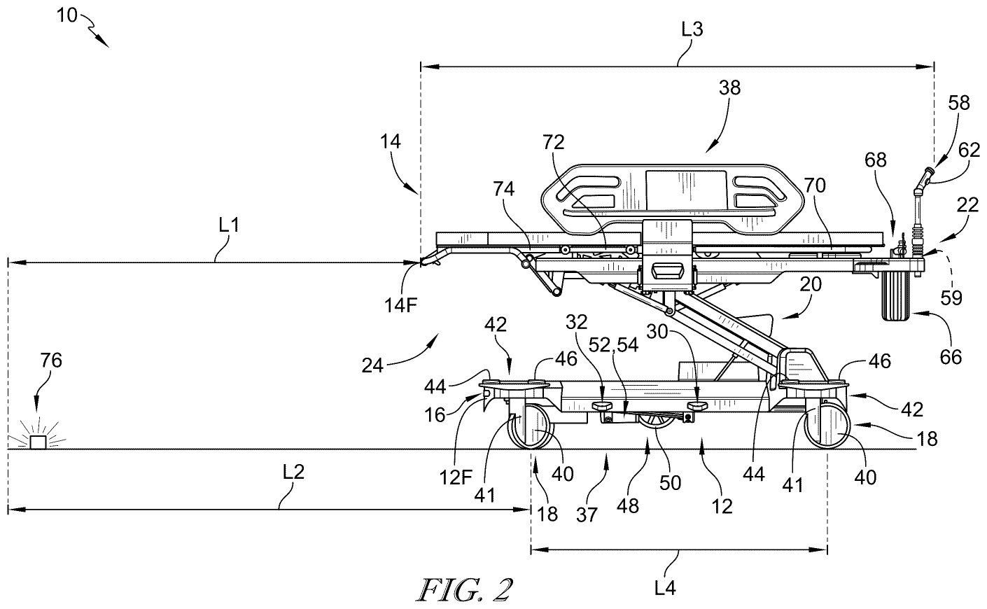

The patient support apparatus 10 includes a brake/steer mechanism 37 supported by the lower frame 12, as shown in FIGS. 1 and 2. Each of the plurality of casters 18 included in the brake/steer mechanism 37 has a caster wheel 40 and a caster stem 41. The brake/steer mechanism 37 is of the type known in the art and able to transition the operation of the plurality of casters 18 between a brake mode, a neutral mode, and a steer mode. In the brake mode of the plurality of casters 18, rotation of the caster wheel 40 of the caster 18 and rotation of the caster stem 41 (i.e., swiveling) is prevented. In the neutral mode of the plurality of casters 18, the caster wheel 40 of the caster 18 is free to rotate and the caster stem 41 is free to rotate. In the steer mode, the caster stem 41 is secured against rotation and the caster wheel 40 is free to rotate so that the caster wheel 40 serves as a tracking wheel to assist with steering of the patient support apparatus 10. In the steer mode, rotation of the caster stem 41 is precluded.

In the present embodiment, the caster 18 positioned at the left foot end of the patient support apparatus 10 serves as the steer caster. In other embodiments, a different caster 18 may be placed in steer mode. When one of the casters 18 is in the steer mode, the remaining casters 18 are permitted to swivel and rotate. The activation of the brake/steer mechanism 37 is provided by an actuator 42 which is positioned at each of the plurality of casters 18, as shown in FIG. 1. Each actuator 42 includes a brake pedal 44 and a steer pedal 46. The pedals 44, 46 allow a caregiver to actuate the brake/steer mechanism 37 at multiple positions about the periphery of the patient support apparatus 10.

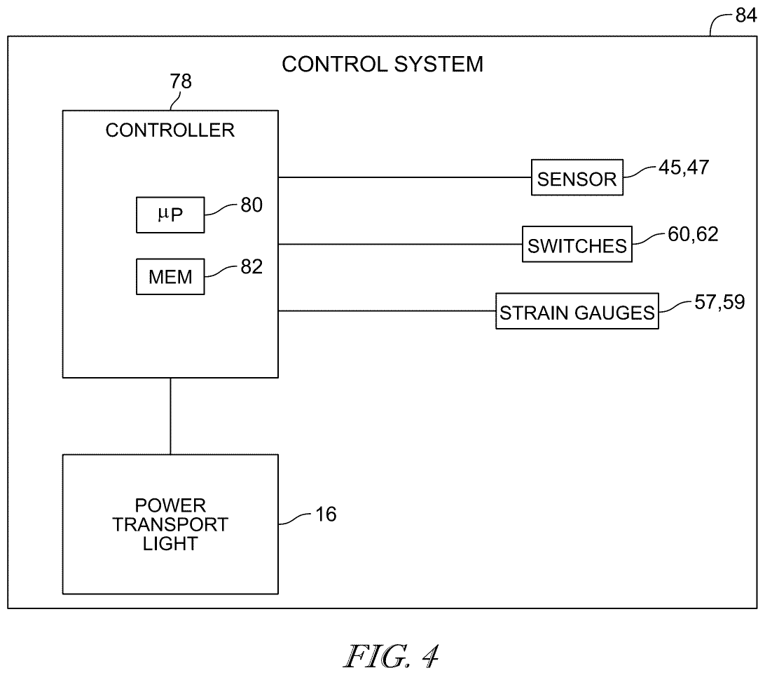

The brake/steer mechanism 37 includes at least two sensors 45, 47 configured to provide information relative to the mode of the brake/steer mechanism 37 to a controller 78 of the patient support apparatus 10, as suggested in FIG. 4. When the brake/steer mechanism 37 is placed in the brake mode via the brake pedal 44, the sensor 45 is engaged so that the sensor 45 is activated to provide an indication to the controller 78 that the brake/steer mechanism 37 is in the brake mode. When the brake/steer mechanism 37 is placed in the steer mode via the steer pedal 46, the sensor 47 is engaged to provide an indication to the controller 78 that the brake/steer mechanism 37 is in the steer mode. In some embodiments, the sensors 45, 47 are each a limit switch that is engaged to provide the signal to the controller 78.

In some embodiments, the brake/steer mechanism 37 includes a powered drive wheel assembly 48, as shown in FIG. 2, to assist the caregiver in moving the patient support apparatus 10. The powered drive wheel assembly 48 includes a powered drive wheel 50, a deploy motor 52, and a drive motor 54. The powered drive wheel assembly 48 is positioned in the center of the lower frame 12, as shown in FIG. 2. The powered drive wheel 50 is deployed via the deploy motor 52 to engage the floor, and the drive motor 54 drives rotation of the powered drive wheel 50.

The patient support apparatus 10 includes a pair of push handles 56, 58 supported on the upper frame 14, as shown in FIG. 1. The push handles 56, 58 are collapsible into stowed positions so that the push handles 56, 58 can be positioned out of the way of a caregiver who needs access to a patient from the head end 22 of the patient support apparatus 10. In some embodiments, the push handles 56, 58 include respective activation switches 60, 62. The activation switches 60, 62 are used to enable the operation of the powered drive wheel assembly 48. For example, the activation switches 60, 62 may include force sensing load cells that provide an input to the powered drive wheel assembly 48. The activation switches 60, 62 are configured to be actuated by the hand of the caregiver when the caregiver grips the push handles 56, 58. In some embodiments, when the push handles 56, 58 are in use, strain gauges 57, 59 are engaged. For example, when a caregiver applies pressure to the push handles 56, 58, the strain gauges 57, 59 provide a signal to the controller 78 indicative of the force being applied.

The push handle 56 further includes a user interface 64 that allows a caregiver to select the speed at which the powered drive wheel 50 of the powered drive wheel assembly 48 operates while the powered drive wheel assembly 48 is enabled by activation of the activation switches 60, 62. The powered drive wheel 50 operates to move the patient support apparatus 10 over the floor with minimal effort by a caregiver to assist with transport. In use, the caregiver places the brake/steer mechanism 37 in the steer mode, and then engages both of the activation switches 60, 62 to activate the powered drive wheel assembly 48. In some embodiments, the powered drive wheel assembly 48 is omitted.

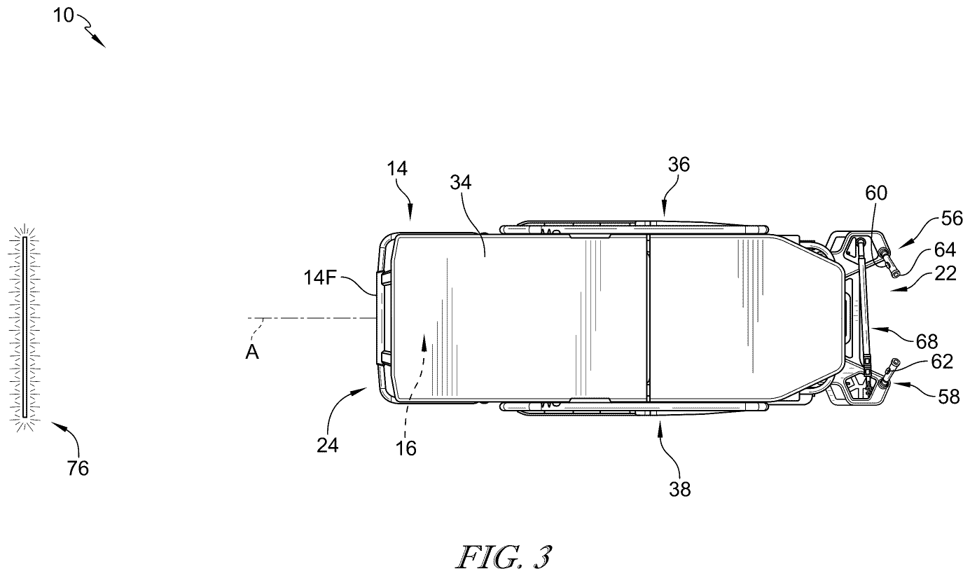

In some embodiments, the patient support apparatus 10 includes an oxygen tank holder 66 that supports an oxygen tank and an IV pole 68, as shown in FIG. 1. The IV pole 68 may fold downwardly as shown in FIGS. 2 and 3. In some embodiments, the oxygen tank holder 66 and/or the IV pole 68 may be omitted.

The patient support apparatus 10 may be moved between a number of configurations. The upper frame 14 includes a head section 70, a thigh section 72, and a foot section 74, as shown in FIG. 1. Sections 70, 72, 74 are each movable relative to each other. For example, head section 70 pivotably raises and lowers relative to thigh section 72, whereas the foot section 74 pivotably raises and lowers relative to the thigh section 72. The patient support apparatus 10 may be the patient support apparatus of U.S. application Ser. No. 18/680,889 filed 31 May 2024, which is expressly incorporated by reference herein.

As shown in FIGS. 1-3, the power indicator transport light 16 is coupled with the lower frame 12. The power indicator transport light 16 changes between an alert mode, in which the power indicator transport light 16 projects an indicator 76 on the floor underlying the patient support apparatus 10 forward of the foot end 24 of the patient support apparatus 10, and an off mode, in which the power indicator transport light 16 does not project the indicator 76 on the floor. The power indicator transport light 16 is changed to the alert mode in response to the patient support apparatus 10 being in a transport mode during which the patient support apparatus 10 is being transported (i.e., moving or being prepared for movement). The power indicator transport light 16 is changed to an off mode in response to the patient support apparatus 10 being in a stationary mode in which the patient support apparatus 10 is not moving. In some embodiments, the power indicator transport light 16 is changed to the alert mode in response to the patient support apparatus 10 being in the transport mode during which the patient support apparatus 10 is moving. In such an embodiment, if the patient support apparatus 10 is moving, the power indicator transport light 16 is in the alert mode, and if the patient support 10 is not moving, even while in the transport mode, the power indicator transport light 16 is in the off mode.

For example, the patient support apparatus 10 is in the stationary mode if the casters 18 are in the brake mode. While the casters 18 are in the brake mode, the power indicator transport light 16 is in the off mode because the patient support apparatus 10 is not moving.

As another example, the patient support apparatus 10 is in the transport mode if at least one of the plurality of casters 18 is in the steer mode. While at least one of the plurality of casters 18 is in the steer mode, the power indicator transport light 16 is in the alert mode because the patient support apparatus 10 is moving (or being prepared for movement). As an additional example, the patient support apparatus 10 is in the transport mode if none of the plurality of casters 18 are in the brake mode.

As an additional example, the patient support apparatus 10 is in the transport mode if the activation switches 60, 62 of the push handles 56, 58 are activated such that the powered drive wheel assembly 48 is enabled. While the activation switches 60, 62 of the push handles 56, 58 are activated, the power indicator transport light 16 is in the alert mode because the patient support apparatus 10 is moving.

In the illustrative embodiment of FIGS. 1-3, the power indicator transport light 16 is coupled to a front end 12F of the lower frame 12. Though shown and described as being coupled to the front end 12F of the lower frame 12, the power indicator transport light 16 may be coupled to the patient support apparatus 10 elsewhere, such as an underside 14U of the upper frame 14 or a front end 14F of the upper frame 14. The power indicator transport light 16 may be coupled anywhere on the patient support apparatus 10 forward of the casters 18 at the foot end 24 of the upper frame 14.

The indicator 76 is projected perpendicularly on the floor underlying the patient support apparatus 10 relative to the axis A, as shown in FIG. 3. Illustratively, the indicator 76 forms a line on the floor that extends perpendicularly along the floor relative to the axis A. As the patient support apparatus 10 is being transported, the indicator 76 moves with the patient support apparatus 10 such that the indicator 76 is always projected forward of the foot end 24 of the upper frame 14.

In the illustrative embodiment of FIG. 1, the power indicator transport light 16 comprises a laser. The laser may be a class 1 or a class 2 laser. In some embodiments, the power indicator transport light 16 comprises at least one light emitting diode (LED). A laser may provide benefits over an LED as the laser has reduced power consumption. In some embodiments, the power indicator transport light 16 flashes on the floor.

Illustratively, the indicator 76 is projected on the floor at least five feet in front of the foot end 24 of the upper frame 14, as shown in FIG. 3. In other words, a distal end of the indicator 76 (i.e., an end of the indicator 76 farthest from the patient support apparatus 10) is a first distance L1 from the front end 14F of the upper frame 14, as shown in FIG. 2. In some embodiments, the indicator 76 is projected on the floor between about five feet and about ten feet in front of the foot end 24 of the upper frame 14. As such, the indicator 76 gives sufficient notice to others in hallways that the patient support apparatus 10 is in close proximity. For example, if the patient support apparatus 10 is being transported through a hallway, the indicator 76 is projected on the floor in front of the foot end 24 of the upper frame 14 such that other people in hallways connecting to the hallway that the patient support apparatus 10 is traveling through see the indicator 76 on the floor prior to seeing the patient support apparatus 10 and turning a corner. Thus, due to the indicator 76, the people will not turn the corner and run into the patient support apparatus 10. Because the indicator 76 is at least five feet in front of the foot end 24 of the upper frame 14, people see the indicator 76 with sufficient notice to stop and wait for the patient support apparatus 10 to pass or to get out of the way.

The distal end of the indicator 76 is a second distance L2 from the foot end caster wheels 40, as shown in FIG. 2. A third distance L3 is measured between the front end 14F of the upper frame 14 and the pair of push handles 56, 58, as shown in FIG. 2. The third distance L3 is a length of the patient support apparatus 10. A fourth distance L4 is measured between the foot end caster wheels 40 and the head end caster wheels 40, as shown in FIG. 2. Illustratively, the first distance L1 is greater than the fourth distance L4, and the second distance L2 is greater than the third distance L3.

As shown in FIG. 4, the patient support apparatus 10 includes the controller 78 as part of a control system 84. The controller 78 includes a microprocessor 80 and a memory 82. The controller 78 is in communication with the power indicator transport light 16, the sensors 45, 47, the activation switches 60, 62 and/or the strain gauges 57, 59. The microprocessor 80 receives inputs related to the status of the patient support apparatus 10 and utilizes instructions stored in the memory 82 to operate the power indicator transport light 16. The inputs to the microprocessor 80 are from the sensors 45, 47, the activation switches 60, 62 and/or the strain gauges 57, 59. Thus, the controller 78 controls whether the power indicator transport light 16 is in the alert mode or in the off mode depending upon the status of the patient support apparatus 10.

As an example, in response to the brake/steer mechanism 37 being in the steer mode (i.e., the patient support apparatus 10 is in the transport mode), the microprocessor 80 receives a signal from the sensor 47. Based on the signal indicating that the brake/steer mechanism 37 is in the steer mode, the controller 78 sends a signal to the power indicator transport light 16 to change the power indicator transport light 16 from the off mode to the alert mode.

As another example, in response to the brake/steer mechanism 37 being in the brake mode (i.e., the patient support apparatus 10 is in the stationary mode), the microprocessor 80 receives a signal from the sensor 45. Based on the signal indicating that the brake/steer mechanism 37 is in the brake mode, the controller 78 sends a signal to the power indicator transport light 16 to change the power indicator transport light 16 to the off mode.

As an additional example, in response to the activation of the powered drive wheel 50 (i.e., the patient support apparatus 10 is in the transport mode), the microprocessor 80 receives a signal from the activation switches 60, 62 and/or the strain gauges 57, 59. Based on the signal indicating that the patient support apparatus 10 is in the transport mode, the controller 78 sends a signal to the power indicator transport light 16 to change the power indicator transport light 16 to the alert mode.

As another example, in response to the deactivation of the powered drive wheel 50 (i.e., the patient support apparatus 10 is in the stationary mode), the microprocessor 80 receives a signal from the activation switches 60, 62 and/or the strain gauges 57, 59. Based on the signal indicating that the patient support apparatus 10 is in the stationary mode, the controller 78 sends a signal to the power indicator transport light 16 to change the power indicator transport light 16 from the alert mode to the off mode. The power indicator transport light 16 automatically changes from the off mode to the alert mode in response to the patient support apparatus 10 changing from the stationary mode to the transport mode. Likewise, the power indicator transport light 16 automatically changes from the alert mode to the off mode in response to the patient support apparatus 10 changing from the transport mode to the stationary mode.

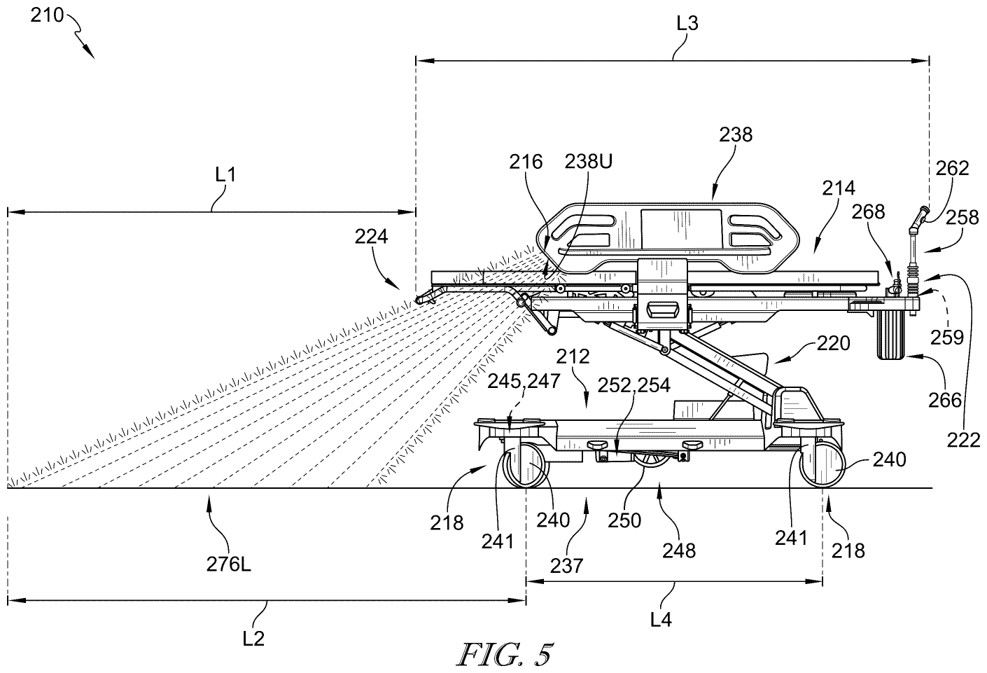

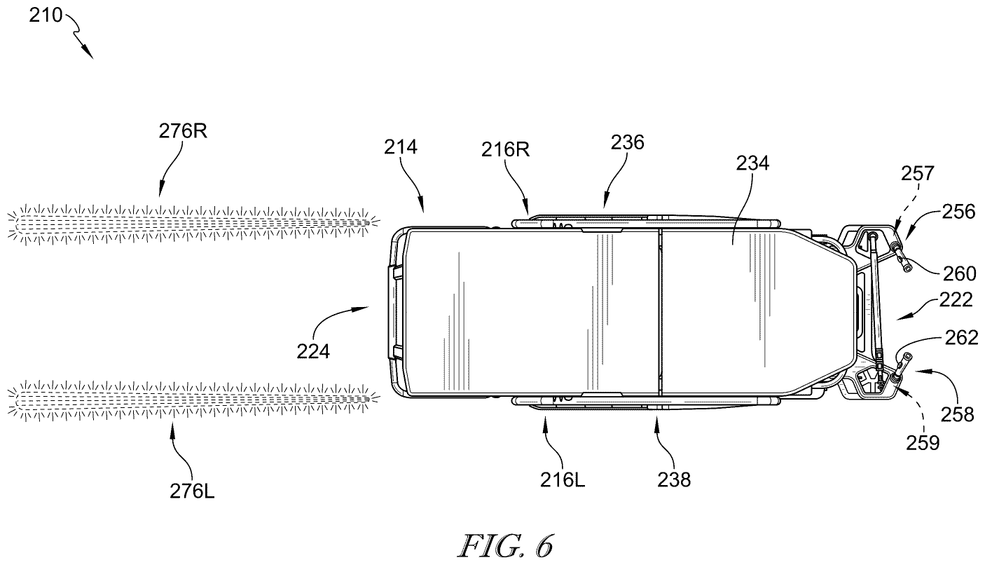

Another embodiment of a patient support apparatus 210 is shown in FIGS. 5 and 6. The patient support apparatus 210 is the same as the patient support apparatus 10, except for a different power indicator transport light 216. The patient support apparatus 210 includes a lower frame 212, an upper frame 214, and the power indicator transport light 216, as shown in FIG. 5. The lower frame 212 is supported on a plurality of casters 218 above a floor underlying the patient support apparatus 210.

The lower frame 212 supports a lift mechanism 220 near a head end 222 of the patient support apparatus 210, as shown in FIG. 5. The patient support apparatus 210 extends between the head end 222 and a foot end 224 thereof along an axis A. The lift mechanism 220 provides cantilevered support of the upper frame 214 and is configured to raise, lower, and tilt the upper frame 214 relative to the lower frame 212 while the lift mechanism 220 is activated.

The upper frame 214 is supported above the lower frame 212 and configured to support a patient thereon, as suggested in FIG. 5. The upper frame 214 supports a mattress 234. The upper frame 214 also supports a right siderail 236 and a left siderail 238 of the patient support apparatus 210. The siderails 236, 238 are spaced from each other in a lateral dimension of the patient support apparatus 210.

The patient support apparatus 210 includes a brake/steer mechanism 237 supported by the lower frame 212, as shown in FIG. 5. Each of the plurality of casters 218 included in the brake/steer mechanism 237 has a caster wheel 240 and a caster stem 241. The brake/steer mechanism 237 transitions the operation of the plurality of casters 218 between a brake mode, a neutral mode, and a steer mode. In the brake mode of the plurality of casters 218, rotation of the caster wheel 240 of the caster 218 and rotation of the caster stem 241 (i.e., swiveling) is prevented. In the neutral mode of the plurality of casters 218, the caster wheel 240 of the caster 218 is free to rotate and the caster stem 241 is free to rotate. In the steer mode, the caster stem 241 is secured against rotation and the caster wheel 240 is free to rotate so that the caster wheel 240 serves as a tracking wheel to assist with steering of the patient support apparatus 210.

The brake/steer mechanism 237 includes at least two sensors 245, 247 configured to provide information relative to the mode of the brake/steer mechanism 237 to a controller, such as the controller 78. When the brake/steer mechanism 237 is placed in the brake mode, the sensor 245 is engaged so that the sensor 245 is activated to provide an indication to the controller that the brake/steer mechanism 237 is in the brake mode. When the brake/steer mechanism 237 is placed in the steer mode, the sensor 247 is engaged to provide an indication to the controller that the brake/steer mechanism 237 is in the steer mode. In some embodiments, the sensors 245, 247 are each a limit switch that is engaged to provide the signal to the controller.

In some embodiments, the brake/steer mechanism 237 includes a powered drive wheel assembly 248, as shown in FIG. 5, to assist the caregiver in moving the patient support apparatus 210. The powered drive wheel assembly 248 includes a powered drive wheel 250, a deploy motor 252, and a drive motor 254. The powered drive wheel assembly 248 is positioned in the center of the lower frame 212, as shown in FIG. 5. The powered drive wheel 250 is deployed via the deploy motor 252 to engage the floor, and the drive motor 254 drives rotation of the powered drive wheel 250.

The patient support apparatus 210 includes a pair of push handles 256, 258 supported on the upper frame 214, as shown in FIG. 6. In some embodiments, the push handles 256, 258 include respective activation switches 260, 262. The activation switches 260, 262 are used to enable the operation of the powered drive wheel assembly 248. For example, the activation switches 260, 262 may include force sensing load cells that provide an input to the powered drive wheel assembly 248. The activation switches 260, 262 are configured to be actuated by the hand of the caregiver when the caregiver grips the push handles 256, 258. In some embodiments, when the push handles 256, 258 are in use, strain gauges 257, 259 are engaged. For example, when a caregiver applies pressure to the push handles 256, 258, the strain gauges 257, 259 provide a signal to the controller indicative of the force being applied.

In some embodiments, the patient support apparatus 210 includes an oxygen tank holder 266 that supports an oxygen tank and an IV pole 268, as shown in FIG. 5. In some embodiments, the oxygen tank holder 266 and/or the IV pole 268 may be omitted.

As shown in FIGS. 5 and 6, the power indicator transport light 216 illustratively includes a right side power indicator transport light 216R and a left side power indicator transport light 216L. The right side power indicator transport light 216R is coupled to an underside 236U of the right siderail 236, and the left side power indicator transport light 216L is coupled to an underside 238U of the left siderail 238. The power indicator transport lights 216R, 216L change between an alert mode, in which each of the power indicator transport lights 216R, 216L project an indicator 276R, 276L (a right side indicator 276R and a left side indicator 276L) on the floor underlying the patient support apparatus 210 forward of the foot end 224 of the patient support apparatus 210, and an off mode, in which each of the power indicator transport lights 216R, 216L do not project the indicator 276R, 276L on the floor. The power indicator transport lights 216R, 216L are changed to the alert mode in response to the patient support apparatus 210 being in a transport mode during which the patient support apparatus 210 is moving (or being prepared for movement). The power indicator transport lights 216R, 216L are changed to an off mode in response to the patient support apparatus 210 being in a stationary mode in which the patient support apparatus 210 is not moving.

Each of the power indicator transport lights 216R, 216L is coupled to an angled portion of the underside 236U, 238U of the siderails 236, 238 relative to the floor such that the indicators 276R, 276L are projected forwardly beyond the foot end 224 of the upper frame 214 (as opposed to being coupled a portion of the siderails 236, 238 that is parallel to the floor).

The patient support apparatus 210 is in the stationary mode if the casters 218 are in the brake mode. While the casters 218 are in the brake mode, the power indicator transport lights 216R, 216L are in the off mode because the patient support apparatus 210 is not moving.

As another example, the patient support apparatus 210 is in the transport mode if at least one of the plurality of casters 218 is in the steer mode. While at least one of the plurality of casters 218 is in the steer mode, the power indicator transport lights 216R, 216L are in the alert mode because the patient support apparatus 210 is moving. As an additional example, the patient support apparatus 210 is in the transport mode if none of the plurality of casters 218 are in the brake mode.

As an additional example, the patient support apparatus 210 is in the transport mode if the activation switches 260, 262 of the push handles 256, 258 are activated such that the powered drive wheel assembly 248 is enabled. While the activation switches 260, 262 of the push handles 256, 258 are activated, the power indicator transport lights 216R, 216L are in the alert mode because the patient support apparatus 210 is moving.

The indicators 276R, 276L are projected on the floor parallel to one another and parallel to the axis A, as shown in FIG. 6. Illustratively, each of the indicators 276R, 276L forms a line on the floor that extends parallel along the floor relative to the axis A and the siderails 236, 238. As the patient support apparatus 210 is being transported, the indicators 276R, 276L move with the patient support apparatus 210 such that the indicators 276R, 276L are always projected forward of the foot end 224 of the upper frame 214.

In the illustrative embodiment of FIG. 1, the power indicator transport light 216 comprises at least one light emitting diode (LED). In some embodiments, the power indicator transport light 216 comprises a laser. In some embodiments, the power indicator transport light 216 flashes on the floor.

Illustratively, the indicators 276R, 276L are projected on the floor to extend at least five feet in front of the foot end 224 of the upper frame 214, as shown in FIG. 6. In other words, a distal end of the indicators 276R, 276L (i.e., an end of the indicators 276R, 276L farthest from the patient support apparatus 210) is a first distance L1 from the foot end 224 of the upper frame 214, as shown in FIG. 5.

In some embodiments, the indicators 276R, 276L are projected on the floor between about five feet and about ten feet in front of the foot end 224 of the upper frame 214. A distance of projection of each of the indicators 276R, 276L in front of the foot end 224 of the upper frame 214 may depend, at least in part, on a height of the upper frame 214 (and, thus, the siderails 236, 238) relative to the floor. For example, the closer the upper frame 214 is to the floor, the smaller the distance of projection.

The distal end of the indicators 276R, 276L is a second distance L2 from the foot end caster wheels 240, as shown in FIG. 5. A third distance L3 is measured between the foot end 224 of the upper frame 214 and the pair of push handles 256, 258, as shown in FIG. 5. The third distance L3 is a length of the patient support apparatus 210. A fourth distance L4 is measured between the foot end caster wheels 240 and the head end caster wheels 240, as shown in FIG. 5. Illustratively, the first distance L1 is greater than the fourth distance L4, and the second distance L2 is greater than the third distance L3.

As such, the indicators 276R, 276L give advance notice to others in hallways, for example, that the patient support apparatus 210 is in close proximity. For example, if the patient support apparatus 210 is being transported through a hallway, the indicators 276R, 276L are projected on the floor in front of the foot end 224 of the upper frame 214 such that other people in hallways connecting to the hallway that the patient support apparatus 210 is traveling through see the indicators 276R, 276L on the floor prior to seeing the patient support apparatus 210. Thus, due to the indicators 276R, 276L, people will not turn the corner and accidentally run into the patient support apparatus 210. Because the indicators 276R, 276L are at least five feet in front of the foot end 224 of the upper frame 214, people see the indicators 276R, 276L with sufficient notice to stop before turning the corner or to get out of the way. The indicators 276R, 276L also show the width of the patient support apparatus 210, as suggested in FIG. 6.

The controller is in communication with the power indicator transport lights 216R, 216L, the sensors 245, 247, the activation switches 260, 262 and/or the strain gauges 257, 259. The microprocessor of the controller, such as the microprocessor 80, receives inputs related to the status of the patient support apparatus 210 and utilizes instructions stored in the memory, such as the memory 82, to operate the power indicator transport light 216. The inputs to the microprocessor are from the sensors 245, 247, the activation switches 260, 262 and/or the strain gauges 257, 259. Thus, the controller controls whether the power indicator transport light 216 is in the alert mode or in the off mode depending upon the status of the patient support apparatus 210.

As an example, in response to the brake/steer mechanism 237 being in the steer mode (i.e., the patient support apparatus 210 is in the transport mode), the microprocessor receives a signal from the sensor 247. Based on the signal indicating that the brake/steer mechanism 237 is in the steer mode, the controller sends a signal to the power indicator transport lights 216R, 216L to change the power indicator transport lights 216R, 216L from the off mode to the alert mode.

As another example, in response to the brake/steer mechanism 237 being in the brake mode (i.e., the patient support apparatus 210 is in the stationary mode), the microprocessor receives a signal from the sensor 245. Based on the signal indicating that the brake/steer mechanism 237 is in the brake mode, the controller sends a signal to the power indicator transport lights 216R, 216L to change the power indicator transport lights 216R, 216L to the off mode.

As an additional example, in response to the activation of the powered drive wheel 250 (i.e., the patient support apparatus 210 is in the transport mode), the microprocessor receives a signal from the activation switches 260, 262 and/or the strain gauges 257, 259. Based on the signal indicating that the patient support apparatus 210 is in the transport mode, the controller sends a signal to the power indicator transport lights 216R, 216L to change the power indicator transport lights 216R, 216L to the alert mode.

As another example, in response to the deactivation of the powered drive wheel 250 (i.e., the patient support apparatus 210 is in the stationary mode), the microprocessor receives a signal from the activation switches 260, 262 and/or the strain gauges 257, 259. Based on the signal indicating that the patient support apparatus 210 is in the stationary mode, the controller sends a signal to the power indicator transport lights 216R, 216L to change the power indicator transport lights 216R, 216L from the alert mode to the off mode. The power indicator transport lights 216R, 216L automatically change from the off mode to the alert mode in response to the patient support apparatus 210 changing from the stationary mode to the transport mode. Likewise, the power indicator transport lights 216R, 216L automatically change from the alert mode to the off mode in response to the patient support apparatus 210 changing from the transport mode to the stationary mode.

Another embodiment of a patient support apparatus 310 including a power indicator transport light 316 is shown in FIGS. 7-9. The patient support apparatus 310 includes a lower frame 312, an upper frame 314, and the power indicator transport light 316, as shown in FIG. 7. The lower frame 312 is supported on a plurality of casters 318 above a floor underlying the patient support apparatus 310. The plurality of casters 318 roll along the floor as the patient support apparatus 310 is transported from one location to another. The upper frame 314 is configured to support a patient thereon. The power indicator transport light 316 is coupled with the upper frame 314 and configured to provide notice to surrounding areas that the patient support apparatus 310 is in close proximity during transport of the patient support apparatus 310 so that collisions with the patient support apparatus 310 are minimized.

The lower frame 312 supports a lift mechanism 320 of the patient support apparatus 310, as shown in FIG. 7. The patient support apparatus 310 extends between a head end 322 and a foot end 324 thereof along an axis A (i.e., along a longitudinal length of the patient support apparatus 310 that extends between the head end 322 and the foot end 324 thereof). The lift mechanism 320 provides support of the upper frame 314 and is configured to move the upper frame 314 vertically relative to the lower frame 312 when the lift mechanism 320 is activated. The lift mechanism 320 includes a head end linkage 326 and a foot end linkage 328. Each of the linkages 326, 328 are independently operable and may be operated to cause the patient support apparatus 310 to move into a tilt position, in which the head end 322 of the upper frame 314 is positioned lower than the foot end 324 of the upper frame 314. The patient support apparatus 310 may also be moved to a reverse tilt position, in which the foot end 324 of the upper frame 314 is positioned lower than the head end 322 of the upper frame 314.

The upper frame 314 supports a load frame 327, as shown in FIG. 7. The load frame 327 supports a head deck 370, which is movable relative to the load frame 327. The load frame 327 also supports an articulated seat deck 329, which is also movable relative to the load frame 327, and a fixed seat deck 331. Also supported from the load frame 327 is a foot deck 374 that is articulated and moveable relative to the load frame 327. The foot deck 374 in the illustrative embodiment of FIG. 7 provides for powered pivoting of the foot deck 374 and manual extension and retraction of the foot deck 374 to vary the length of the foot deck 374. In other embodiments, powered pivoting of the foot deck 374 may be omitted and the related movement may be caused manually, or may follow movement of the articulated seat deck 329. In addition, in some embodiments, extension and retraction of the foot deck 374 may be powered by an actuator.

The foot deck 374 includes a first portion 333 and a second portion 330, which moves relative to the first portion 333 to vary the size of the foot deck 374. The second portion 330 moves generally longitudinally relative to the first portion 333 to vary the longitudinal length of the foot deck 374 and, thereby, the longitudinal length of the patient support apparatus 310.

A foot panel 366 is supported from the second portion 330 of the foot deck 374 and extends vertically from an upper surface of the second portion 330 to form a barrier at the foot end 324 of the patient support apparatus 310, as shown in FIG. 7. A head panel 332 is positioned on an upright structure 352 of the lower frame 312 and extends vertically to form a barrier at the head end 322 of the patient support apparatus 310. A right head siderail 354 is supported from the head deck 370 and is moveable between a raised position shown in FIG. 7 and a lowered position as is known in the art. A left head siderail 350 is also moveable between the raised position of FIG. 7 and a lowered position. As shown in FIG. 7, in the raised position, the head siderails 354, 350 extend above a mattress 334 of the patient support apparatus 310 while the head siderails 354, 350 are in a raised position.

The patient support apparatus 310 also includes a right foot siderail 336 and a left foot siderail 338, each of which is supported directly from the load frame 327, as shown in FIG. 7. Each of the siderails 354, 350, 336, 338 are operable to be lowered to a position below the upper surface of the mattress 334. It should be noted that when the head deck 370 is moved, the head siderails 354, 350 move with the head deck 370 so that the head siderails 354, 350 maintain their relative position to the patient.

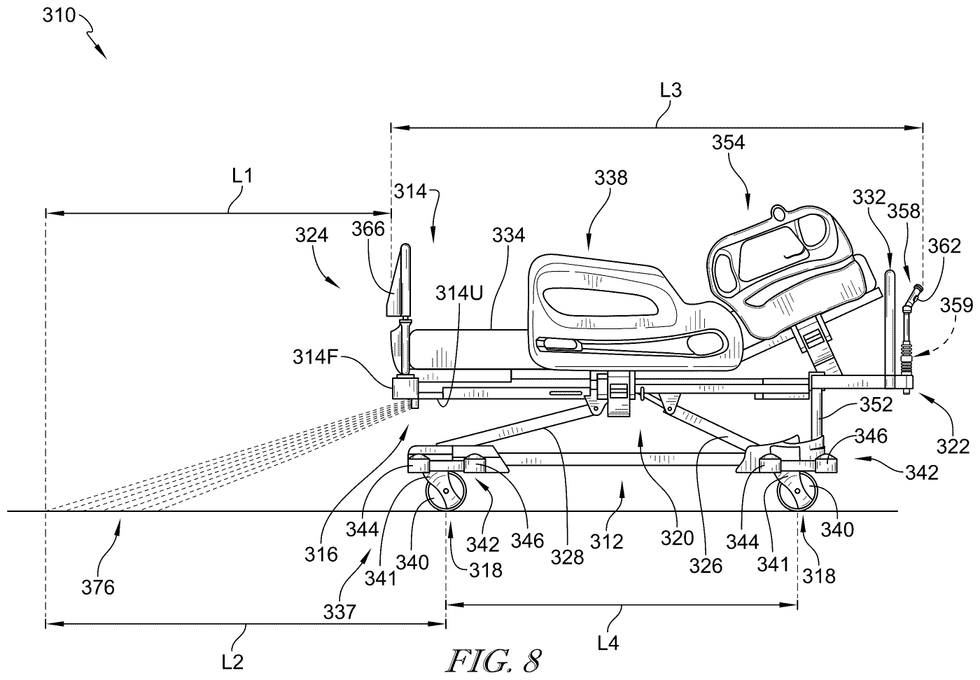

The patient support apparatus 310 includes a brake/steer mechanism 337 supported by the lower frame 312, as shown in FIGS. 7 and 8. Each of the plurality of casters 318 included in the brake/steer mechanism 337 has a caster wheel 340 and a caster stem 341. The brake/steer mechanism 337 is of the type known in the art and able to transition the operation of the plurality of casters 318 between a brake mode, a neutral mode, and a steer mode. In the brake mode of the plurality of casters 318, rotation of the caster wheel 340 of the caster 318 and rotation of the caster stem 341 (i.e., swiveling) is prevented. In the neutral mode of the plurality of casters 318, the caster wheel 340 of the caster 318 is free to rotate and the caster stem 341 is free to rotate. In the steer mode, the caster stem 341 is secured against rotation and the caster wheel 340 is free to rotate such that the caster wheel 340 serves as a tracking wheel to assist with steering of the patient support apparatus 310. In the steer mode, rotation of the caster stem 341 is precluded.

In the present embodiment, the caster 318 positioned at the left foot end of the patient support apparatus 310 serves as the steer caster. In other embodiments, a different caster 318 may be placed in steer mode. When one of the casters 318 is in the steer mode, the remaining casters 318 are permitted to swivel and rotate. The activation of the brake/steer mechanism 337 is provided by an actuator 342 which is positioned at each of the plurality of casters 318, as shown in FIG. 7. Each actuator 342 includes a brake pedal 344 and a steer pedal 346. The pedals 344, 346 allow a caregiver to actuate the brake/steer mechanism 337 at multiple positions about the periphery of the patient support apparatus 310.

The brake/steer mechanism 337 includes at least two sensors 345, 347 configured to provide information relative to the mode of the brake/steer mechanism 337 to a controller, such as the controller 78. When the brake/steer mechanism 337 is placed in the brake mode via the brake pedal 344, the sensor 345 is engaged so that the sensor 345 is activated to provide an indication to the controller that the brake/steer mechanism 337 is in the brake mode. When the brake/steer mechanism 337 is placed in the steer mode via the steer pedal 346, the sensor 347 is engaged to provide an indication to the controller that the brake/steer mechanism 337 is in the steer mode. In some embodiments, the sensors 345, 347 are each a limit switch that is engaged to provide the signal to the controller.

In some embodiments, the brake/steer mechanism 337 includes a powered drive wheel assembly 348 to assist the caregiver in moving the patient support apparatus 310. The powered drive wheel assembly 348 includes a powered drive wheel, a deploy motor, and a drive motor. The powered drive wheel assembly 348 is positioned in the center of the lower frame 312. The powered drive wheel is deployed via the deploy motor to engage the floor, and the drive motor drives rotation of the powered drive wheel.

The patient support apparatus 310 includes a pair of push handles 356, 358 supported on the upper frame 314, as shown in FIG. 7. The push handles 356, 358 are collapsible into stowed positions so that the push handles 356, 358 can be positioned out of the way of a caregiver who needs access to a patient from the head end 322 of the patient support apparatus 310. In some embodiments, the push handles 356, 358 include respective activation switches 360, 362. The activation switches 360, 362 are used to enable the operation of the powered drive wheel assembly 348. For example, the activation switches 360, 362 may include force sensing load cells that provide an input to the powered drive wheel assembly 348. The activation switches 360, 362 are configured to be actuated by the hand of the caregiver when the caregiver grips the push handles 356, 358. In some embodiments, when the push handles 356, 358 are in use, strain gauges 357, 359 are engaged. For example, when a caregiver applies pressure to the push handles 356, 358, the strain gauges 357, 359 provide a signal to the controller indicative of the force being applied.

The push handle 356 further includes a user interface 364 that allows a caregiver to select the speed at which the powered drive wheel of the powered drive wheel assembly 348 operates while the powered drive wheel assembly 348 is enabled by activation of the activation switches 360, 362. The powered drive wheel operates to move the patient support apparatus 310 over the floor with minimal effort by a caregiver to assist with transport. In use, the caregiver places the brake/steer mechanism 337 in the steer mode, and then engages both of the activation switches 360, 362 to activate the powered drive wheel assembly 348. In some embodiments, the powered drive wheel assembly 348 is omitted.

As shown in FIGS. 7-9, the power indicator transport light 316 is coupled with the upper frame 314. The power indicator transport light 316 changes between an alert mode, in which the power indicator transport light 316 projects an indicator 376 on the floor underlying the patient support apparatus 310 forward of the foot end 324 of the patient support apparatus 310, and an off mode, in which the power indicator transport light 316 does not project the indicator 376 on the floor. The power indicator transport light 316 is changed to the alert mode in response to the patient support apparatus 310 being in a transport mode during which the patient support apparatus 310 is moving (or being prepared for movement). The power indicator transport light 316 is changed to an off mode in response to the patient support apparatus 310 being in a stationary mode in which the patient support apparatus 310 is not moving.

For example, the patient support apparatus 310 is in the stationary mode if the casters 318 are in the brake mode. While the casters 318 are in the brake mode, the power indicator transport light 316 is in the off mode because the patient support apparatus 310 is not moving.

As another example, the patient support apparatus 310 is in the transport mode if at least one of the plurality of casters 318 is in the steer mode. While at least one of the plurality of casters 318 is in the steer mode, the power indicator transport light 316 is in the alert mode because the patient support apparatus 310 is moving. As an additional example, the patient support apparatus 310 is in the transport mode if none of the plurality of casters 318 are in the brake mode.

As an additional example, the patient support apparatus 310 is in the transport mode if the activation switches 360, 362 of the push handles 356, 358 are activated such that the powered drive wheel assembly 348 is enabled. While the activation switches 360, 362 of the push handles 356, 358 are activated, the power indicator transport light 316 is in the alert mode because the patient support apparatus 310 is moving.

In the illustrative embodiment of FIGS. 7-9, the power indicator transport light 316 is coupled to an underside 314U of the upper frame 314. Though shown and described as being coupled to the underside 314U of the upper frame 314, the power indicator transport light 316 may be coupled to the patient support apparatus 310 elsewhere, such as a front end 314F of the upper frame 14. The power indicator transport light 316 may be coupled anywhere on the patient support apparatus 310 having a clear line of sight forward of the foot end 324 of the upper frame 314.

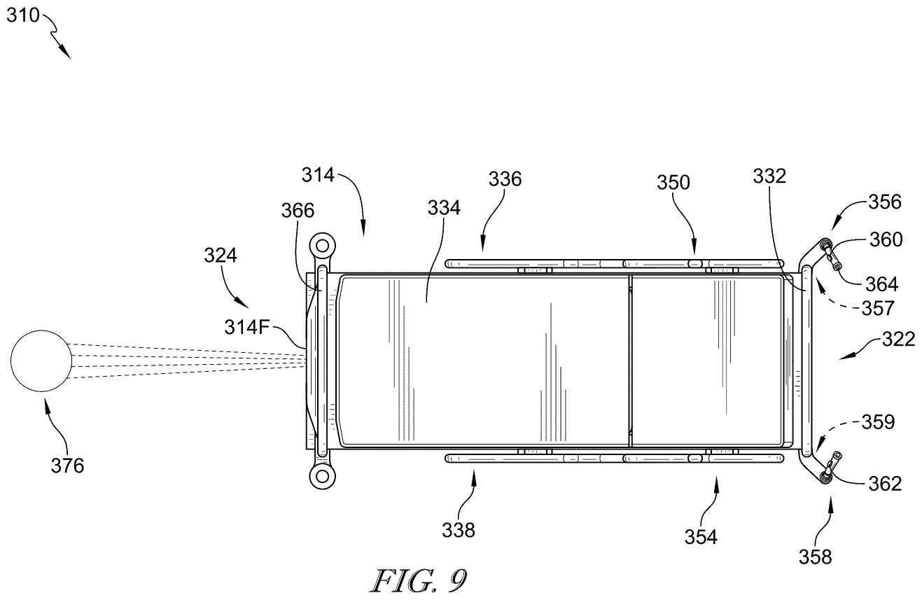

The indicator 376 is projected on the floor underlying the patient support apparatus 310 to form a symbol, an icon, or an image, as shown in FIG. 9. As the patient support apparatus 310 is being transported, the indicator 376 moves with the patient support apparatus 310 such that the indicator 376 is always projected forward of the foot end 324 of the upper frame 314.

In the illustrative embodiment of FIG. 7, the power indicator transport light 316 comprises at least one light emitting diode (LED). In some embodiments, the LED emits light that passes through a cutout of the power indicator transport light 316 to project a particular symbol, icon, and/or image on the floor. In some embodiments, the power indicator transport light 316 includes a projector and a slide such that the LED emits light that is conducted through the projector and through the slide positioned in the projector such that a particular symbol, icon, and/or image is projected on the floor. In some embodiments, the power indicator transport light 316 flashes on the floor.

Illustratively, the indicator 376 is projected on the floor at least five feet in front of the foot end 324 of the upper frame 314, as shown in FIGS. 8 and 9. In other words, a distal end of the indicator 376 (i.e., an end of the indicator 376 farthest from the patient support apparatus 310) is a first distance L1 from the front end 314F of the upper frame 314, as shown in FIG. 8.

In some embodiments, the indicator 376 is projected on the floor between about five feet and about ten feet in front of the foot end 324 of the upper frame 314. A distance of projection of the indicator 376 in front of the foot end 324 of the upper frame 314 may depend, at least in part, on a height of the upper frame 314 relative to the floor. For example, the closer the upper frame 314 is to the floor, the smaller the distance of projection.

The distal end of the indicator 376 is a second distance L2 from the foot end caster wheels 340, as shown in FIG. 8. A third distance L3 is measured between the front end 314F of the upper frame 314 and the pair of push handles 356, 358, as shown in FIG. 8. The third distance L3 is a length of the patient support apparatus 310. A fourth distance L4 is measured between the foot end caster wheels 340 and the head end caster wheels 340, as shown in FIG. 8. Illustratively, the first distance L1 is greater than the fourth distance L4.

As such, the indicator 376 gives sufficient notice to others in hallways, for example, that the patient support apparatus 310 is in close proximity. For example, if the patient support apparatus 310 is being transported through a hallway, the indicator 376 is projected on the floor in front of the foot end 324 of the upper frame 314 such that other people in hallways connecting to the hallway that the patient support apparatus 310 is traveling through see the indicator 376 on the floor prior to seeing the patient support apparatus 310. Thus, due to the indicator 376, the people will not turn the corner and accidentally run into the patient support apparatus 310. Because the indicator 376 is at least five feet in front of the foot end 324 of the upper frame 314, people see the indicator 376 with advance notice to stop prior to turning the corner or to get out of the way.

The controller is in communication with the power indicator transport light 316, the sensors 345, 347, the activation switches 360, 362 and/or the strain gauges 357, 359. The microprocessor, such as the microprocessor 80, receives inputs related to the status of the patient support apparatus 310 and utilizes instructions stored in the memory, such as the memory 82, to operate the power indicator transport light 316. The inputs to the microprocessor are from the sensors 345, 347, the activation switches 360, 362 and/or the strain gauges 357, 359. Thus, the controller controls whether the power indicator transport light 316 is in the alert mode or in the off mode depending upon the status of the patient support apparatus 310.

As an example, in response to the brake/steer mechanism 337 being in the steer mode (i.e., the patient support apparatus 310 is in the transport mode), the microprocessor receives a signal from the sensor 347. Based on the signal indicating that the brake/steer mechanism 337 is in the steer mode, the controller sends a signal to the power indicator transport light 316 to change the power indicator transport light 316 from the off mode to the alert mode.

As another example, in response to the brake/steer mechanism 337 being in the brake mode (i.e., the patient support apparatus 310 is in the stationary mode), the microprocessor receives a signal from the sensor 345. Based on the signal indicating that the brake/steer mechanism 337 is in the brake mode, the controller sends a signal to the power indicator transport light 316 to change the power indicator transport light 316 to the off mode.

As an additional example, in response to the activation of the powered drive wheel (i.e., the patient support apparatus 310 is in the transport mode), the microprocessor receives a signal from the activation switches 360, 362 and/or the strain gauges 357, 359. Based on the signal indicating that the patient support apparatus 310 is in the transport mode, the controller sends a signal to the power indicator transport light 316 to change the power indicator transport light 316 to the alert mode.

As another example, in response to the deactivation of the powered drive wheel (i.e., the patient support apparatus 310 is in the stationary mode), the microprocessor receives a signal from the activation switches 360, 362 and/or the strain gauges 357, 359. Based on the signal indicating that the patient support apparatus 310 is in the stationary mode, the controller sends a signal to the power indicator transport light 316 to change the power indicator transport light 316 from the alert mode to the off mode. The power indicator transport light 316 automatically changes from the off mode to the alert mode in response to the patient support apparatus 310 changing from the stationary mode to the transport mode. Likewise, the power indicator transport light 316 automatically changes from the alert mode to the off mode in response to the patient support apparatus 310 changing from the transport mode to the stationary mode.

Although certain illustrative embodiments have been described in detail above, variations and modifications exist within the scope and spirit of this disclosure as described and as defined in the following claims.

1. A patient support apparatus comprising:
a frame positioned above a floor, the frame extending between a head end and a foot end thereof along an axis and
a power indicator transport light coupled with the frame and configured to change between (i) an alert mode in which the power indicator transport light projects an indicator on the floor underlying the frame forward of the foot end of the frame in response to the patient support apparatus being in a transport mode during which the patient support apparatus is moving and (ii) an off mode in which the power indicator transport light does not project the indicator on the floor in response to the patient support apparatus being in a stationary mode in which the patient support apparatus is not moving.

2. The patient support apparatus of claim 1, wherein the frame includes a lower frame and an upper frame supported above the lower frame and configured to support a patient.

3. The patient support apparatus of claim 2, wherein the power indicator transport light is coupled to a forward end of the lower frame, and wherein the indicator is projected by the power indicator transport light perpendicularly along the floor relative to the axis.

4. The patient support apparatus of claim 2, wherein the power indicator transport light is coupled to an underside of the upper frame.

5. The patient support apparatus of claim 2, further comprising a first siderail coupled to a first side of the upper frame and a second siderail coupled to a second side of the upper frame opposite the first side, and wherein the power indicator transport light comprises a first power indicator transport light coupled to an underside of the first siderail and a second power indicator transport light coupled to an underside of the second siderail.

6. The patient support apparatus of claim 5, wherein the first power indicator transport light forms a first indicator along the floor extending parallel to the axis and the second power indicator transport light forms a second indicator along the floor extending parallel to the axis.

7. The patient support apparatus of claim 1, wherein the indicator is projected on the floor at least five feet forward of the foot end of the frame.

8. The patient support apparatus of claim 1, further comprising a plurality of casters configured to support the frame on the floor, wherein the plurality of casters changes between a brake mode in which rotation and swiveling of each of the plurality of casters is prevented and a steer mode in which one of the plurality of casters is prevented from swiveling while the one of the plurality of casters is free to rotate.

9. The patient support apparatus of claim 8, wherein, in response to the plurality of casters being in the steer mode, the patient support apparatus is in the transport mode.

10. The patient support apparatus of claim 9, wherein, in response to the plurality of casters being in the brake mode, the patient support apparatus is in the stationary mode.

11. The patient support apparatus of claim 8, further comprising a controller in communication with the power indicator transport light, the controller including a processor and a memory having instructions stored therein which, when executed by the processor, cause the processor to control the power indicator transport light to change between the off mode and the alert mode in response to determining that the patient support apparatus is in the stationary mode or in the transport mode, respectively.

12. The patient support apparatus of claim 11, wherein the controller is configured to receive a first signal from a sensor indicative of the plurality of casters being in the steer mode and the patient support apparatus being in the transport mode, and wherein the controller is configured to receive a second signal from the sensor indicative of the plurality of casters being in the brake mode and the patient support apparatus being in the stationary mode.

13. A method comprising:
coupling a power indicator transport light to a frame of a patient support apparatus,
determining a status of the patient support apparatus,
in response to determining that the status of the patient support apparatus is a transport mode, changing the power indicator transport light from an off mode to an alert mode in which the power indicator transport light projects an indicator on a floor underlying the frame forward of a foot end of the frame, and
in response to determining that the status of the patient support apparatus is a stationary mode, changing the power indicator transport light from the alert mode to the off mode in which the power indicator transport light does not project the indicator on the floor.

14. The method of claim 13, wherein changing the power indicator transport light from an off mode to an alert mode includes projecting the indicator perpendicularly along the floor relative to an axis extending through the patient support apparatus from a head end to the foot end thereof.

15. The method of claim 13, wherein changing the power indicator transport light from an off mode to an alert mode includes projecting the indicator on the floor as a symbol.

16. The method of claim 13, wherein changing the power indicator transport light from an off mode to an alert mode includes projecting a first indicator on the floor and a second indicator on the floor such that the first and second indicators extend along the floor parallel to an axis extending through the patient support apparatus from a head end to the foot end thereof.

17. The method of claim 13, wherein changing the power indicator transport light from an off mode to an alert mode includes projecting the indicator on the floor at least five feet forward of the foot end of the frame.

18. The method of claim 13, further comprising determining that the status of the patient support apparatus is the transport mode in response to a plurality of casters of the patient support apparatus being in a steer mode in which one of the plurality of casters is prevented from swiveling while the one of the plurality of casters is free to rotate.

19. The method of claim 18, further comprising determining that the status of the patient support apparatus is the stationary mode in response to the plurality of casters being in a brake mode in which rotation and swiveling of each of the plurality of casters is prevented.

20. The method of claim 13, further comprising determining that the status of the patient support apparatus is the transport mode in response to a powered drive wheel of the patient support apparatus being activated.
